(19) United States
(12) Patent Application Publication
(10) Pub. No.: US 2024/0043725 A1
(43) Pub. Date: Feb. 8, 2024

(54) METHODS OF BONDING COPPER AND ARTICLES FORMED THEREBY

(71) Applicant: 3M INNOVATIVE PROPERTIES COMPANY, St. Paul, MN (US)

(72) Inventor: Matthew J. Kryger, Hudson, WI (US)

(21) Appl. No.: 18/257,676

(22) PCT Filed: Dec. 15, 2021
(86) PCT No.: PCT/IB2021/061799

§ 371 Date: Jun. 15, 2023

Related U.S. Application Data
(60) Provisional application No. 63/127,438, filed on Dec. 18, 2020.

(51) Int. Cl. C09J 163/00; C09J 11/06

(52) U.S. Cl. CPC C09J 163/00; C09J 11/06; C09J 2400/163; C09J 2301/50; C09J 2301/408

(57) ABSTRACT

Articles that include at least two substrates; and an adhesion promoter, wherein the adhesion promoter is a compound of formula I, (I) wherein x is an integer from 1 to 4, y is an integer from 2 to 6, and z is an integer from 1 to 6; and a structural adhesive positioned at least between the two substrates. Structural adhesives including such adhesion promoters and methods for bonding two substrates are also disclosed herein.

### GOVERNMENT SUPPORT CLAUSE

This invention was made with government support under Subcontract No. 4000153415 to Prime Contract No. DE-AC05-OR22725 awarded by the Department of Energy (DOE). The government has certain rights in the invention.

### BACKGROUND

Conventionally, in the heating, ventilation and air conditioning (HVAC) heat exchanger industry, pipes are joined together using a process called brazing. Brazing is a pipe bonding process where metal objects are joined together by melting and flowing a filler metal into the joint. Typically, the filler metal has a lower melting point than the metals it is joining. This process typically is done at elevated temperatures (on the order of several hundred degrees Celsius) using an open flame. Skilled labor is needed to hand apply the brazing material at manufacturers that manually assemble heat exchangers. This production process often results in joined metal pipes with leaks and pinhole defects due to the manual nature of the process.

One possible solution to the aforementioned challenges in brazing is the use of a structural adhesive to replace the metal filler used. Ideally, this structural adhesive would be robust enough to stand up under all the conditions a brazed joint would typically encounter during usage, as well as pass all required testing by HVAC manufacturers. These tests include robust burst performance, resistance to refrigerants and water, high temperature performance, and good dispensability, among others.

The predominate metal substrate used in the HVAC industry is copper. One particularly challenging set of conditions that is often a customer requirement is adhesion to these copper substrates under high temperature aqueous environments. In initial screening and development of an adhesive for this set of conditions, a test was developed where bonded copper substrates were exposed to high temperature (130° C.) while submerged under water. It was noted, that after aging for 4 days under these conditions, all commercial adhesives screened using this test failed adhesively to the copper surface at very low shear strengths.

Accordingly, what is needed in the industry are methods of bonding materials, such as copper, that can produce a bond that stands up to extreme conditions such as high temperatures and aqueous environments.

### SUMMARY OF THE DISCLOSURE

The present disclosure provides methods of bonding copper articles together as well as articles formed thereby.

Also disclosed herein are articles that include at least two substrates, at least one of which is copper; and an adhesion promoter, wherein the adhesion promoter is a compound of formula I,

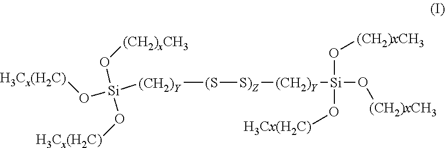

wherein x is an integer from 1 to 4, y is an integer from 2 to 6, and z is an integer from 1 to 6; and a structural adhesive positioned at least between the two substrates.

Also disclosed herein are methods of bonding two substrates, at least one of which is copper, together, the method comprising: applying an adhesion promoter to at least a portion of at least one substrate, wherein the adhesion promoter is a compound of formula I,

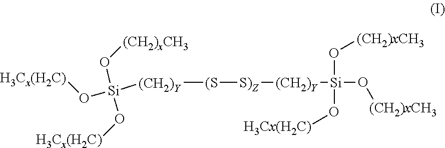

wherein x is an integer from 1 to 4, y is an integer from 2 to 6, and z is an integer from 1 to 6; applying a structural adhesive composition to a portion of at least one substrate; contacting the portion of the at least one substrate that has the structural adhesive composition applied thereto with a second substrate; and curing the structural adhesive composition to bond the two substrates together, wherein the adhesion promoter is applied before the structural adhesive composition, within the structural adhesive composition or both.

Additional disclosure relates to bonding two substrates, at least one of which is copper, together, the method comprising: applying an adhesion promoter to at least a portion of at least one substrate, wherein the adhesion promoter is a compound of formula I,

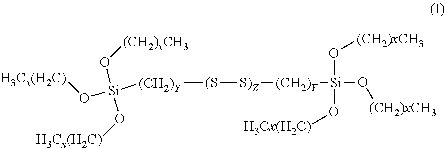

wherein x is an integer from 1 to 4, y is an integer from 2 to 6, and z is an integer from 1 to 6; applying a structural adhesive composition to a portion of at least one substrate; contacting the portion of the at least one substrate that has the structural adhesive composition applied thereto with a second substrate; and curing the structural adhesive composition to bond the two substrates together, wherein the adhesion promoter is applied before the structural adhesive composition, within the structural adhesive composition or both.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other claims are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.) and any sub-ranges (e.g., 1 to 5 includes 1 to 4, 1 to 3, 2 to 4, etc.).

As used herein, the term “room temperature” refers to a temperature of 20° C. to 25° C.

The term “in the range” or “within a range” (and similar statements) includes the endpoints of the stated range.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The phrase “adhesive composition” refers to a composition, which on its own or in combination with another composition may, once cured, adhere two materials together, thereby forming an adhesive bond. In some instances, an adhesive composition in combination with another adhesive composition can form an adhesive bond once the adhesive compositions are cured. In some such instances, the adhesive compositions may be the same, some such adhesive compositions can be referred to as one part or one component (1K) adhesives. Illustrative 1K adhesives include, for example 1K epoxy adhesives, 1K acrylate adhesives, 1K urethane adhesives, as well as hybrids of the above chemistries. In some instances, two adhesive compositions components may be different, some such adhesive compositions can be referred to as two part or two component (2K) adhesives. 2K adhesives are generally made up of a Resin (Part A) and a Hardener (Part B). Generally, these materials are mixed prior to application of the materials onto the substrate surface. After the two parts are mixed, curing can occur, not necessarily immediately and not necessarily without an outside influence (e.g., heat, energy, etc.). Illustrative 2K adhesives include, for example, 2K epoxy adhesives, 2K acrylate adhesives, and 2K urethane adhesives as well as hybrids of the above chemistries. It should be noted that there is no additional inference to be made from referring to a composition as first or second, it is merely for the sake of convenience and clarity.

The phrase “adhesive bond” is a result of curing the first and/or first and second precursor adhesive compositions. The adhesive bond in this case serves to adhere the joining region of the first article to the joining region of the second article.

The phrase “female element” refers to an article that has a hollow generally cylindrical body with an internal diameter. A female element can be formed by using a pipe with a larger starting diameter than the “male element” or be accomplished by flaring/widening the end of a smaller diameter pipe (i.e., flaring a “male element” so that it becomes a larger diameter member that can serve as a “female element”).

The phrase “male element” refers to an article that has a hollow generally cylindrical body that fits within the female element and has an external diameter slightly less than the internal diameter of the female element. Generally, the difference between the outer diameter of the male element and the inner diameter of the female element is on the order of 2-50 thousandths of an inch, most typically 5-20 thousandths of an inch.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF FIGURES

FIGS. 1A-1C are schematic illustrations of illustrative articles that may be useful or made using disclosed methods.

### DETAILED DESCRIPTION OF ILLUSTRATIVE EMBODIMENTS

The present disclosure provides methods of joining two articles, at least one of which is copper, together. Articles are also disclosed herein.

The usage of adhesion promoters of formula I as primers applied to a substrate surface prior to bonding or included in an adhesive composition that will adhere the two substrates together can result in improved adhesion to copper of the structural adhesive under high temperature, aqueous conditions, or both. This improved performance may allow the methods of bonding to replace the usage of braze materials in the HVAC industry.

The methods disclosed herein are methods of forming a bond between two copper substrates and/or a copper substrate and a substrate of another metal. The methods include a step of applying an adhesion promoter to at least a portion of at least one copper substrate, wherein the adhesion promoter is a compound of formula I,

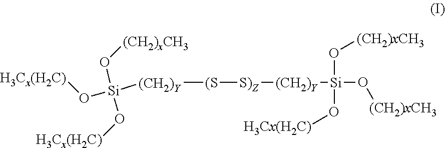

wherein x is an integer from 1 to 4, y is an integer from 2 to 6, and z is an integer from 1 to 6; applying a structural adhesive composition to a portion of at least one substrate; contacting the portion of the at least one substrate that has the structural adhesive composition applied thereto with a second substrate; and curing the structural adhesive composition to bond the two substrates together, wherein the adhesion promoter is applied before the structural adhesive composition, within the structural adhesive composition or both.

Articles formed using such methods are also disclosed herein. Disclosed articles can include at least two substrates, at least one of which is copper; and an adhesion promoter, wherein the adhesion promoter is a compound of formula I,

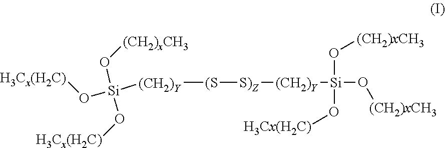

wherein x is an integer from 1 to 4, y is an integer from 2 to 6, and z is an integer from 1 to 6; and a structural adhesive positioned at least between the two substrates.

Articles where the compound of formula I was applied before the structural adhesive was applied showed dramatically improved bonding to the copper substrate under aging conditions and resulted in adhesive that retained upwards of 65% of its initial shear strength on copper upon aging at high temperatures under an aqueous environment. Articles where the compound of formula I was applied within the structural adhesive composition showed dramatically improved bonding to the copper substrate under aging conditions and resulted in adhesive that retained upwards of 75% of its initial shear strength on copper upon aging at high temperatures under an aqueous environment.

In some methods, initial steps can include applying an adhesive composition to at least the joining region of the first article or the male element. In some such embodiments, the adhesive composition can be a 2K epoxy, 2K acrylic, or 2K urethane. In some such embodiments, the adhesive composition can be a 1 part (1K) epoxy adhesives, 1K acrylic adhesives, or 1K urethane.

Generally, adhesive compositions that can be used herein are structural adhesives. Structural adhesives may be divided into two broad categories: one-part adhesives and two-part adhesives. With a one-part adhesive, a single composition comprises all the materials necessary to obtain a final cured adhesive. In the case of thermally cured epoxies, these materials are typically applied to the substrates to be bonded and exposed to elevated temperatures (e.g., temperatures greater than 50° C.) to cure the adhesive.

In contrast, two-part adhesives comprise two components. The first component, typically referred to as the “base resin component,” comprises the curable resin, e.g., a curable epoxy resin. The second component, typically referred to as the “accelerator component,” comprises the curing agent(s) and catalysts. Various other additives may be included in one or both components.

Epoxy resins function as a cross-linkable component in the structural adhesive. The term “epoxy resin” is used herein to mean any of monomeric, dimeric, oligomeric or polymeric epoxy materials containing at least one epoxy functional group per molecule. Such compounds include monomeric epoxy compounds and epoxides of the polymeric type and can be aliphatic, cycloaliphatic, aromatic or heterocyclic. Monomeric and oligomeric epoxy compounds have at least one and preferably one to four polymerizable epoxy groups per molecule. In polymeric type epoxides or epoxy resins, there may be many pendent epoxy groups (for example, a glycidyl methacrylate polymer could have several thousand pendent epoxy groups per average molecular weight).

The molecular weight of the epoxy resins may vary from low molecular weight monomeric or oligomeric epoxy resins with a molecular weight, for example, from about 100 g/mol to epoxy resins with a molecular weight of about 50,000 g/mol or more and may vary greatly in the nature of their backbone and substituent groups. For example, the backbone may be of any type, and substituent groups thereon can be any group not having a nucleophilic group or electrophilic group (such as an active hydrogen atom) which is reactive with an oxirane ring. Illustrative of permissible substituent groups are halogens, ester groups, ethers, sulfonate groups, siloxane groups, nitro groups, amide groups, nitrile groups, phosphate groups, etc. Mixtures of epoxy resins can also be used. In some embodiments, a structural adhesive comprises a mixture of two or more epoxy resins in order to modify and adapt the mechanical properties of the cross-linked structural adhesive with respect to specific requirements.

Types of epoxy resins that can be used include, for example, the reaction product of bisphenol A and epichlorohydrin, the reaction product of phenol and formaldehyde (novolac resin) and epichlorohydrin, peracid epoxies, glycidyl esters, glycidyl ethers, the reaction product of epichlorohydrin and p-amino phenol, the reaction product of epichlorohydrin and glyoxal tetraphenol and the like.

Epoxides that are particularly useful in the present invention are of the glycidyl ether type. Suitable glycidyl ether epoxides may include those in general formula (I):

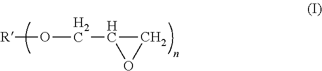

wherein R′ is alkyl, alkyl ether, or aryl; n is at least 1 and, in particular, in the range from 1 to 4. Suitable glycidyl ether epoxides of formula (I) include glycidyl ethers of Bisphenol A and F, aliphatic diols or cycloaliphatic diols. In some embodiments the glycidyl ether epoxides of formula (I) have a molecular weight in the range of from about 170 g/mol to about 10,000 g/mol. In other embodiments, the glycidyl ether epoxides of formula (I) have a molecular weight in the range of from about 200 g/mol to about 3,000 g/mol.

Useful glycidyl ether epoxides of formula (I) include linear polymeric epoxides having terminal epoxy groups (for example, a diglycidyl ether of polyoxyalkylene glycol) and aromatic glycidyl ethers (for example, those prepared by reacting a dihydric phenol with an excess of epichlorohydrin). Examples of useful dihydric phenols include resorcinol, catechol, hydroquinone, and the polynuclear phenols including p,p′-dihydroxydibenzyl, p,p′-dihydroxyphenylsulfone, p,p′-dihydroxybenzophenone, 2,2′-dihydroxyphenyl sulfone, p,p′-dihydroxybenzophenone, 2,2-dihydroxy-1,1-dinaphrhylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihy droxy dipheny Icy clohexane. Suitable commercially available aromatic and aliphatic epoxides include diglycidylether of bisphenol A (for example, available under the tradename EPON 828, EPON 872, EPON 1001, EPON 1310 and EPONEX 1510 from Hexion Specialty Chemicals GmbH in Rosbach, Germany), DER-331, DER-332, and DER-334 (available from Dow Chemical Co. in Midland, MI); diglycidyl ether of bisphenol F (for example, EPICLON 830 available from Dainippon Ink and Chemicals, Inc.); PEGioooDGE (available from Polysciences, Inc. in Warrington, PA); silicone resins containing diglycidyl epoxy functionality; flame retardant epoxy resins (for example, DER 580, a brominated bisphenol type epoxy resin available from Dow Chemical Co. in Midland, MI); 1,4-dimethanol cyclohexyl diglycidyl ether; and 1,4-butanediol diglycidyl ether. Other epoxy resins based on bisphenols are commercially available under the tradenames D.E.N., EPALLOY and EPILOX. Additional useful resins can include, for example Erisys GA240, Araldite MY0500, and Araldite MY720 (all commercially available from Huntsman International, LLC Texas). In some embodiments, the structural adhesives of the present invention may comprise from about 20% to about 90% by weight epoxy resin. In other embodiments, the structural adhesives may comprise from about 40% to about 70% by weight epoxy resin. In yet other embodiments, the structural adhesives may comprise from about 40% to about 60% by weight epoxy resin.

Methods and articles included herein can apply the adhesion promoter before the adhesive composition or within the adhesive composition. The adhesion promoter is a compound of formula I

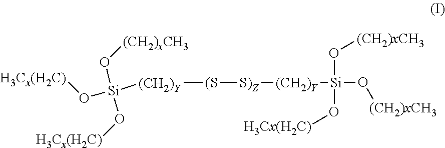

wherein x is an integer from 1 to 4, y is an integer from 2 to 6, and z is an integer from 1 to 6. Any compound of formula I can be used as an adhesion promoter (either via direct deposition onto the copper substrate or within the structural adhesive composition). In some embodiments, a composition that includes compounds having different number of sulfurs can be utilized as adhesion promoters. In some embodiments, Bis[3-(triethoxysilyl) propyl] disulfide (commercially available under the trade designation “SIB 1824.6”, from Gelest, Inc, Morrisville, PA), Bis[3-(triethoxysilyl) propyl] tetrasulfide (commercially available under the trade designation “SIB 1825.0”, from Gelest, Inc, Morrisville, PA), or combinations thereof can be utilized.

In embodiments where the adhesion promoter is applied before the structural adhesive, the adhesion promoter can be solvent coated onto the copper substrate. The adhesion promoter of formula I can be combined with an organic solvent or a solvent composition and the composition can be utilized to solvent coat the compound of formula I onto the substrate. In some embodiments, the organic solvent can include ethanol, methanol, propanol, other protic solvents, or combinations thereof. Optionally, water can also be added to the solvent or solvent composition to help promote condensation of the silane groups. The amount of the compound of formula I in the solvent(s) can range from 0.1 to 5 weight percent (wt %), for example, or more specifically from 0.1 to 1 wt %.

In embodiments where the adhesion promoter is applied within the structural adhesive composition, the compound of formula I can be present in the adhesive composition in an amount from 0.1 wt % to 5 wt %. Although various structural adhesive compositions can be utilized, in some embodiments, useful structural adhesive compositions can include epoxy resins. In some embodiments, the adhesion promoter can be mixed with all components of the structural adhesive except for the catalyst and the accelerant, which can then be added after the composition has cooled.

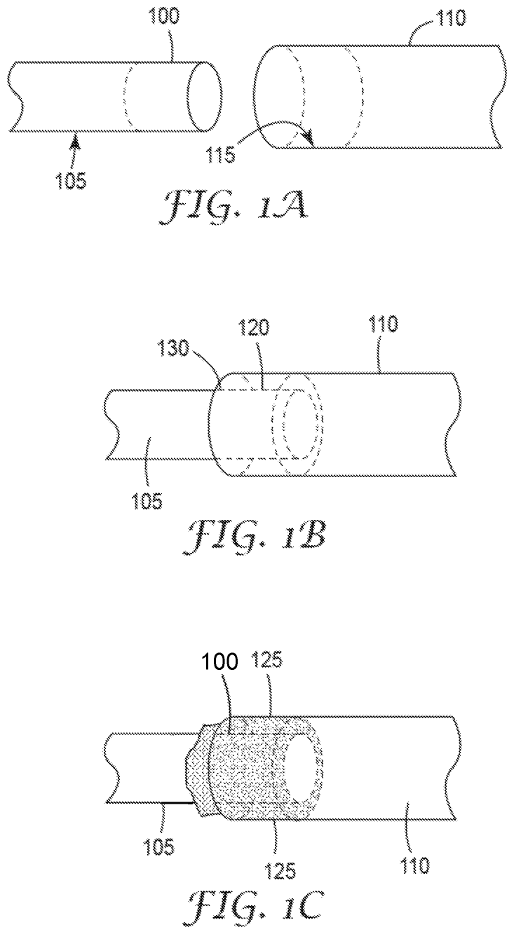

Disclosed methods can include methods of bonding two copper articles together. FIGS. 1A to 1C show illustrative configurations of two articles that can be bonded together.

FIG. 1A illustrates a first article 105. The first article 105 is generally configured as a male element and is made of or includes a first metal. The first article 105 includes a joining region 100. FIG. 1A also shows a second article 110. The second article 110 is generally configured as a female element and is made of or includes a second metal. The second article 110 also includes a joining region 115. At least the joining region 100 of the first article 105 or the joining region 115 of the second article 110 is made of copper. In some embodiments either the first article 105 or the second article 110 is made of copper. In some embodiments the first metal and the second metal are different (i.e., one is copper and the other is a different metal). In some embodiments, the first metal and the second metal are the same (i.e., both are copper). Other illustrative metals that can be bonded to a copper article can include, for example, aluminum, stainless steel, or galvanized steel.

FIG. 1B shows the first article 105 and the second article 110 after the first article has been inserted into the second article and form an interface 130. In the particular embodiment depicted in FIG. 1B, the first article 105 can be considered the male part and the second article 110 can be considered the female part.

After, the adhesive composition is applied to the first article, the first and second articles are then put together so the joining regions overlap at the adhesive region 120. Once cured, the adhesive composition that forms the adhesive region 120 forms an adhesive bond. Curing the adhesive composition(s) can be accomplished by applying heat to the adhesive compositions, via the application of certain wavelengths of energy (i.e., microwave triggering of the adhesive), or IR irradiation of the pipe to heat the substrate, or induction curing. The particular method of curing chosen can be based at least in part on the particular adhesive composition(s) being utilized or the substrates being used.

As seen in FIG. 1C, the adhesive bond 125 attaches the first article 105 to the second article 110. The adhesive bond attaches the joining region 100 of the first article 105 to the joining region 115 of the second article 110.

Articles that are joined via disclosed methods may have advantageous properties in comparison to articles joined via other methods. In some embodiments, articles can have improved adhesion after exposure to aging conditions such as high temperatures, aqueous conditions, or some combination thereof.

Articles that are joined herein may have pipe configurations, or irregular configurations (e.g., oval, square, etc.).

### EXEMPLARY ASPECTS

Aspect 1 is an article comprising: at least two substrates, at least one of which is copper; and an adhesion promoter, wherein the adhesion promoter is a compound of formula I,

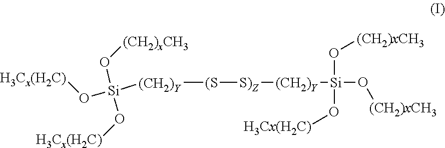

wherein x is an integer from 1 to 4, y is an integer from 2 to 6, and z is an integer from 1 to 6; and a structural adhesive positioned at least between the two substrates.

Aspect 2 is an article according to aspect 1, wherein the adhesion promoter is dispersed within the structural adhesive prior to application of the structural adhesive to the surface of the substrate.

Aspect 3 is an article according to aspect 2, wherein the structural adhesive comprises from about 0.1 to 5 wt % of the adhesion promoter.

Aspect 4 is an article according to any of aspects 1 to 3, wherein the structural adhesive comprises an epoxy resin.

Aspect 5 is an article according to aspect 1, wherein the adhesion promoter is applied to the surface of at least the copper substrate prior to application of the structural adhesive.

Aspect 6 is an article according to any of aspects 1 to 5, wherein the compound of formula I is Bis[3-(triethoxysilyl) propyl] disulfide.

Aspect 7 is an article according to any of aspects 1 to 5, wherein the compound of formula I is Bis[3-(triethoxysilyl) propyl] tetrasulfide.

Aspect 8 is an article according to any of aspects 1 to 7, wherein the article comprises two substrates and both of the substrates are copper.

Aspect 9 is an article according to any of aspects 1 to 7, wherein only one of the at least two substrates is copper.

Aspect 10 is an article according to aspect 9, wherein the article comprises two substrates and the second substrate is selected from aluminum, stainless steel, or galvanized steel.

Aspect 11 is a method of bonding two substrates together, the method comprising: applying an adhesion promoter to at least a portion of at least one substrate, wherein the adhesion promoter is a compound of formula I,

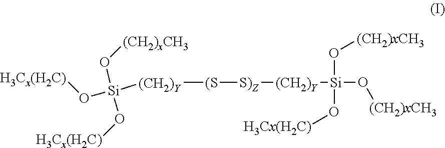

wherein x is an integer from 1 to 4, y is an integer from 2 to 6, and z is an integer from 1 to 6; applying a structural adhesive composition to a portion of at least one substrate; contacting the portion of the at least one substrate that has the structural adhesive composition applied thereto with a second substrate; and curing the structural adhesive composition to bond the two substrates together, wherein the adhesion promoter is applied before the structural adhesive composition, within the structural adhesive composition or both.

Aspect 12 is a method according to aspect 11, wherein the adhesion promoter is dispersed within the structural adhesive composition when the structural adhesive composition is applied to a portion of at least one substrate.

Aspect 13 is a method according to aspect 11, wherein the structural adhesive composition comprises from about 0.1 to 5 wt % of the adhesion promoter.

Aspect 14 is a method according to any of aspects 11 to 13, wherein the structural adhesive composition comprises an epoxy resin.

Aspect 15 is a method according to aspect 11, wherein the adhesion promoter is applied to at least the copper substrate surface before the structural adhesive composition.

Aspect 16 is a method according to aspect 15, wherein the adhesion promoter is solvent coated onto at least the copper substrate prior to application of the structural adhesive composition.

Aspect 17 is a method according to any of aspects 11 to 16, wherein the article comprises two substrates and both of the substrates are copper.

Aspect 18 is a method according to any of aspects 11 to 16, wherein only one of the at least two substrates is copper.

Aspect 19 is a method according to aspect 18, wherein the article comprises two substrates and the second substrate is selected from aluminum, stainless steel, or galvanized steel.

Aspect 20 is a structural adhesive composition comprising: a resin; and from 0.1 to 5 wt % of one or more compounds of formula I,

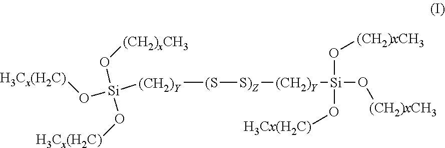

wherein x is an integer from 1 to 4, y is an integer from 2 to 6, and z is an integer from 1 to 6.

Aspect 21 is a structural adhesive according to aspect 20, wherein the resin comprises an epoxy resin.

Aspect 22 is a structural adhesive according to any of aspects 20 to 21, wherein the compound of formula I is Bis[3-(triethoxysilyl) propyl] disulfide.

Aspect 23 is a structural adhesive according to any of aspects 20 to 21, wherein the compound of formula I is Bis[3-(triethoxysilyl) propyl] tetrasulfide.

### EXAMPLES

These examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding.

Unless otherwise noted, all chemicals used in the examples can be obtained from the noted suppliers.

### Materials

| Material | Description |
|---|---|
| Amicure | Dicyandiamide curative, obtained under the trade |
| CG1200 | designation “AMICURE CG1200”, from Evonik, Essen, |
| | Germany |
| OFS-6040 | Glycidylpropyl trimethoxysilane adhesion promoter, |
| | obtained under the trade designation “XIAMETER OFS- |
| | 6040 SILANE”, from Dow Chemical, Midland, MI |
| Carbon black | 20% carbon black dispersed in Bis A epoxy, obtained from |
| paste | Clariant AG, Muttenz, Switzerland |
| EPON 828 | Difunctional Bis A epoxy, obtained under the trade |
| | designation “EPON 828”, from Hexion Inc, Columbus, OH |
| DSPD | N-N′-Disalicyidiene-1,2-propanediamine (CAS # 94-91-7), |
| | obtained by 3M Company, St. Paul, MN |
| SL300 | Hollow ceramic spheres having mean particle size of 100 |
| | micrometers, obtained under the trade designation “E- |
| | SPHERES SL300”, from Envirospheres Pty. Ltd., Lindfield |
| | NSW Australia |
| TS-720 | Hydrophobic amorphous silica, obtained under the trade |
| | designation “CAB-O-SIL TS-720”, from Cabot Corp., |
| | Billerica, MA |
| Toyal 201 | Aluminum Powder with mean diameter of 23 microns, |
| | obtained under the trade designation “TOYAL 201”, from |
| | Toyal America, Lockport, IL |
| MX-257 | Core Shell dispersed in difunctional bis A epoxy, obtained |
| | under the trade designation “KANE-ACE MX-257”, from |
| | Kaneka Corporation, Tokyo, Japan |
| MY0500 | Multifunctional epoxy, obtained under the trade designation |
| | “ARALDITE MY 0500”, from Huntsman Corporation, The |
| | Woodlands, TX |
| PW80 | Mineral Filler, obtained under the trade designation |
| | “MICAFORT PW80”, from LKAB minerals, Lulea, Sweden |
| U52M | Urea cure accelerator, obtained under the trade designation |
| | “OMNICURE U-52M”, from Huntsman Corporation, The |
| | Woodlands, TX |
| D-410 | Rheology modifier, obtained under the trade designation |
| | “RHEOBYK D-410”, from BYK-Chemie GmbH, Wesel, |
| | Germany |
| SIB1824.6 | Silane adhesion promoter, obtained under the trade |
| | designation “SIB 1824.6”, from Gelest, Inc, Morrisville, PA |
| SIB1825.0 | Silane adhesion promoter, obtained under the trade |
| | designation “SIB 1825.0”, from Gelest, Inc, Morrisville, PA |
| OFS-6040 | Glycidylpropyl trimethoxysilane, obtained under the trade |
| | designation “XIAMETER OFS-6040 SILANE”, from Dow |
| | Chemical, Midland, MI |
| KBM-803 | 3-mercaptopropyltrimethoxysilane, obtained under the trade |
| | designation “KBM-803”, from Shin-Etsu Chemical Co., Ltd, |
| | Tokyo, Japan |
| SIM 6474.0 | 3-mercaptopropylmethyldimethoxysilane, obtained under the |
| | trade designation “SIM 6474.0”, from Gelest, Inc, |
| | Morrisville, PA |
| Ethanol | Anhydrous denatured alcohol, available from Sigma Aldrich, |
| | St. Louis, MO |

### Sample Preparation

For Examples 1-2 and Comparative Examples 3-4, all materials except for the catalyst and accelerant (Amicure CG1200 and U52M, respectively) were combined in MAX 100 cups (Flacktek, IncLandrum, SC) and mixed fully on a DAC speed mixer (Flacktek, Inc) for 2 minutes @1800 rpm. After cooling, the catalyst and accelerant were added and mixed in the DAC speed mixer for 2 minutes @1800 RPM. After formulation, all samples were stored in a −20° C. freezer until needed for testing. The formulations for the Examples and Comparative Examples can be found in Table 1 below.

TABLE 1
Formulation Information

| | Example | Example | Comparative | Comparative |
|---|---|---|---|---|
| Raw Material | 1 | 2 | 1 | 2 |
| Amicure | 2.78 | 2.78 | 2.78 | 2.80 |
| CG1200 | | | | |
| Carbon | 1.59 | 1.59 | 1.59 | 1.59 |
| black paste | | | | |
| EPON 828 | 4.78 | 4.78 | 4.78 | 4.80 |
| DSPD | 13.92 | 13.92 | 13.92 | 13.99 |
| SL300 | 0.24 | 0.24 | 0.24 | 0.24 |
| TS-720 | 1.36 | 1.36 | 1.36 | 1.36 |
| Toyal 201 | 25.04 | 25.04 | 25.04 | 25.16 |
| MX-257 | 21.47 | 21.47 | 21.47 | 21.58 |
| MY0500 | 22.27 | 22.27 | 22.27 | 22.38 |
| PW80 | 4.45 | 4.45 | 4.45 | 4.47 |
| U52M | 0.79 | 0.79 | 0.79 | 0.80 |
| D-410 | 0.83 | 0.83 | 0.83 | 0.83 |
| SIB1824.6 | 0.50 | | | |
| SIB1825.0 | | 0.50 | | |
| OFS-6040 | | | 0.50 | |

### Sample Preparation for Adhesive Compositions with Adhesion Promoter Dispersed Therein

Substrate samples were prepared by removing oils/surface contamination using a MEK wipe. The adhesives were applied to the surface of one of the coupons, and the two coupons were bound together using disposable binder clips to give 0.5 inch overlap. The samples were cured at the oven at 150° C. for 30 min. A total of 6 test samples were prepared for each of the adhesive on 3 sets of substrates (copper, aluminum, and stainless steel). Upon curing, the clips were removed from the samples, and the sets were split into two groupings—a set for initial evaluation of properties and a set for accelerated aging.

### Overlap Shear Strength (OLS)

Overlap shear strength was measured by bonding 1×4 inch coupons to 1×4 inch coupons with an 0.5-inch overlap on the 1-inch wide portion of the coupon. Prior to bonding, for testing, overlap shear specimens were clamped into the jaws of a tensile tester and pulled apart to bond failure at a crosshead speed of 0.1 inches per minute. Results of unaged samples were reported in psi and can be found below in Table 2; whereas results from aged samples can be found in Table 3.

### Accelerated Aging of OLS Samples

OLS samples were placed into a 0.6 Liter Parr Vessel (Available from Parr Instrument Company, Moline, Il) and Deionized water was added to the Parr vessel so that the level of water was 0.5 inches below the top of the vessel in order to ensure complete coverage of the adhesive bond by water during aging. The Parr vessel was sealed in order to maintain pressure and heated in a constant temperature oven for 96 hours (4 days) at 130° C. After 4 days of aging, the Parr vessel was allowed to cool to room temperature and the samples were removed and evaluated using the same process as unaged samples.

TABLE 2
OLS Results (Unaged)

| | Copper | Stainless Steel | Aluminum |
|---|---|---|---|
| | Initial (psi) | Initial (psi) | Initial (psi) |
| Example 1 | 3291 +/− 176 | 3928 +/− 133 | 3304 +/− 387 |
| Example 2 | 3239 +/− 31 | 3762 +/− 73 | 3199 +/− 90 |
| Comparative 1 | 3502 +/− 80 | 3828 +/− 104 | 3569 +/− 163 |
| Comparative 2 | 3488 +/− 85 | 3840 +/− 228 | 3419 +/− 300 |

TABLE 3
OLS Results (Aged)

| | Copper | Stainless Steel | Aluminum |
|---|---|---|---|
| | Aged (psi) | Aged (psi) | Aged (psi) |
| Example 1 | 2456 +/− 72 | 3172 +/− 231 | 2928 +/− 185 |
| Example 2 | 2714 +/− 53 | 3103 +/− 66 | 2970 +/− 47 |
| Comparative 1 | 145 +/− 106 | 3480 +/− 150 | 3161 +/− 44 |
| Comparative 2 | 288 +/− 156 | 1293 +/− 107 | 2295 +/− 59 |

### Adhesive Sample Preparation for the Samples with Adhesion Promoter Underlying Adhesive

For the adhesive used in testing, all materials except for the catalyst and accelerant (Amicure CG1200 and U52M, respectively) were combined in a MAX 100 cup and mixed fully on a DAC speed mixer for 2 minutes @1800 rpm. After cooling, the catalyst and accelerant was added and mixed in the DAC speed mixer for 2 minutes seconds @1800 RPM. After formulation, the adhesive sample was stored in a −20° C. freezer until needed for testing. The adhesive formulation for the sample that included a layer of adhesion promotor was the same as the adhesive formulation of Comparative 2 in Table 1 above.

### Primer Sample Preparation

Primer solutions were made by diluting the neat silane compounds into ethanol in a small glass vial. After combining, the solution was shaken vigorously by hand. Composition of the tested primers can be found in Table 4 below.

TABLE 4
Primer Composition

| Raw | Primer | Primer | Compar- | Compar- | Compar- |
|---|---|---|---|---|---|
| Material | 1 | 2 | ative 1 | ative 2 | ative 3 |
| Ethanol | 99 | 99 | 99 | 99 | 99 |
| SIB 1824.6 | 1 | | | | |
| SIB 1825.0 | | 1 | | | |
| SIM 6474.0 | | | 1 | | |
| KBM-803 | | | | 1 | |
| OFS-6040 | | | | | 1 |

### Sample Preparation

In total, 6 sets of samples were created. Five sets of samples were created using the primers shown in Table 4 above, while a sixth set was made as an additional control using no primer. Prior to bonding, substrate samples were prepared by removing oils/surface contamination using a MEK wipe, optionally followed by priming of the metal surface. Priming was done by dropwise addition of the priming solution onto the surface of the metal substrate using a pipette, allowing the ethanol solution to fully wet out the entire surface. After air drying, the primed substrates were heated in an oven for 20 minutes at 150° F. After priming, the adhesives were applied to the surface of one of the coupons, and the two coupons were bound together using disposable binder clips to give 0.5 inch overlap. In the case of the unprimed control, the samples were wiped with MEK and directly bonded using the same process as the primed sample without addition of the priming step. The samples were cured at the oven at 150° C. for 30 min after bonding. A total of 6 test samples were prepared for each of the adhesive on 3 sets of substrates (copper, aluminum, and stainless steel). Upon curing, the clips were removed from the samples, and the sets were split into two groupings—a set for initial evaluation of properties and a set for accelerated aging.

### Overlap Shear Strength (OLS)

Overlap shear strength was measured by bonding 1×4 inch coupons to 1×4 inch coupons with an 0.5-inch overlap on the 1-inch wide portion of the coupon. For testing, overlap shear specimens were clamped into the jaws of a tensile tester and pulled apart to bond failure at a crosshead speed of 0.1 inches per minute.

Results of unaged samples were reported in psi and can be found below in Table 5; whereas results from aged samples can be found in Table 6.

### Accelerated Aging of OLS Samples

OLS samples were placed into a 0.6 Liter Parr Vessel (Available from Parr Instrument Company, Moline, Il) and DI water was added to the Parr vessel so that the level of water was 0.5 inches below the top of the vessel in order to ensure complete coverage of the adhesive bond by water during aging. The Parr vessel was sealed in order to maintain pressure and heated in a constant temperature oven for 96 hours (4 days) at 130C. After 4 days of aging, the Parr vessel was allowed to cool to room temperature and the samples were removed and evaluated using the same process as unaged samples.

TABLE 5
OLS Results (Unaged)

| | Copper | Stainless Steel | Aluminum |
|---|---|---|---|
| | Initial (psi) | Initial (psi) | Initial (psi) |
| Example 1 | 3239 +/− 40 | 3793 +/− 115 | 3468 +/− 480 |
| (SIB 1824.6) | | | |
| Example 2 | 3329 +/− 98 | 3946 +/− 80 | 3557 +/− 108 |
| (SIB 1825.0) | | | |
| Comparative 1 | 3231 +/− 112 | 3656 +/− 234 | 3437 +/− 300 |
| (SIM 4674.0) | | | |
| Comparative 2 | 3235 +/− 106 | 3704 +/− 23 | 3755 +/− 82 |
| (KBM-803) | | | |
| Comparative 3 | 3419 +/− 55 | 3762 +/− 108 | 3668 +/− 393 |
| (OFS-6040) | | | |
| Comparative 4 | 3488 +/− 85 | 3840 +/− 228 | 3419 +/− 300 |
| (Unprimed) | | | |

TABLE 6
OLS Results (Aged)

| | Copper Aged | Stainless Steel | Aluminum |
|---|---|---|---|
| | (psi) | Aged (psi) | Aged (psi) |
| Example 1 | 1724 +/− 295 | 2323 +/− 90 | 2315 +/− 257 |
| (SIB 1824.6) | | | |
| Example 2 | 2205 +/− 87 | 2536 +/− 365 | 2730 +/− 147 |
| (SIB 1825.0) | | | |
| Comparative 1 | 677 +/− 333 | 1550 +/− 485 | 2573 +/− 49 |
| (SIM 4674.0) | | | |
| Comparative 2 | 530 +/− 301 | 1603 +/− 525 | 2560 +/− 101 |
| (KBM-803) | | | |
| Comparative 3 | 334 +/− 59 | 1283 +/− 224 | 2508 +/− 187 |
| (OFS-6040) | | | |
| Comparative 4 | 288 +/− 156 | 1293 +/− 107 | 2295 +/− 59 |
| (Unprimed) | | | |

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. An article comprising:
at least two substrates, at least one of which is copper; and
an adhesion promoter, wherein the adhesion promoter is a compound of formula I, 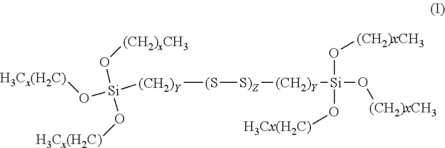
wherein x is an integer from 1 to 4,
y is an integer from 2 to 6, and
z is an integer from 1 to 6; and
a structural adhesive positioned at least between the two substrates.

2. The article according to claim 1, wherein the adhesion promoter is dispersed within the structural adhesive prior to application of the structural adhesive to the surface of the substrate.

3. The article according to claim 2, wherein the structural adhesive comprises from about 0.1 to 5 wt % of the adhesion promoter.

4. The article according to claim 1, wherein the structural adhesive comprises an epoxy resin.

5. The article according to claim 1, wherein the adhesion promoter is applied to the surface of at least the copper substrate prior to application of the structural adhesive.

6. The article according to claim 1, wherein the compound of formula I is Bis[3-(triethoxysilyl) propyl] disulfide.

7. The article according to claim 1, wherein the compound of formula I is Bis[3-(triethoxysilyl) propyl] tetrasulfide.

8. The article according to claim 1, wherein the article comprises two substrates and both of the substrates are copper.

9. The article according to claim 1, wherein only one of the at least two substrates is copper.

10. The article according to claim 9, wherein the article comprises two substrates and the second substrate is selected from aluminum, stainless steel, or galvanized steel.

11. A method of bonding two substrates together, the method comprising:
applying an adhesion promoter to at least a portion of at least one substrate, wherein the adhesion promoter is a compound of formula I, 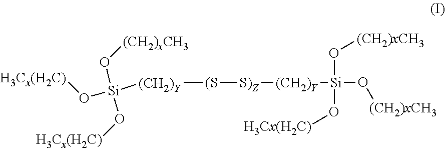
wherein x is an integer from 1 to 4,
y is an integer from 2 to 6, and
z is an integer from 1 to 6;
applying a structural adhesive composition to a portion of at least one substrate; contacting the portion of the at least one substrate that has the structural adhesive composition applied thereto with a second substrate; and
curing the structural adhesive composition to bond the two substrates together,
wherein the adhesion promoter is applied before the structural adhesive composition, within the structural adhesive composition or both.

12. The method according to claim 11, wherein the adhesion promoter is dispersed within the structural adhesive composition when the structural adhesive composition is applied to a portion of at least one substrate.

13. The method according to claim 11, wherein the structural adhesive composition comprises from about 0.1 to 5 wt % of the adhesion promoter.

14. The method according to claim 11, wherein the structural adhesive composition comprises an epoxy resin.

15. The method according to claim 11, wherein the adhesion promoter is applied to at least the copper substrate surface before the structural adhesive composition.

16. The method according to claim 15, wherein the adhesion promoter is solvent coated onto at least the copper substrate prior to application of the structural adhesive composition.

17. The method according to claim 11, wherein the article comprises two substrates and both of the substrates are copper.

18. The method according to claim 11, wherein only one of the at least two substrates is copper.

19. The method according to claim 18, wherein the article comprises two substrates and the second substrate is selected from aluminum, stainless steel, or galvanized steel.

20. A structural adhesive composition comprising:
a resin; and
from 0.1 to 5 wt % of one or more compounds of formula I 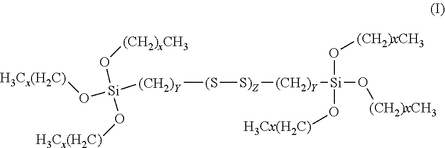
wherein x is an integer from 1 to 4,
y is an integer from 2 to 6, and
z is an integer from 1 to 6.

21. The structural adhesive composition according to claim 20, wherein the resin comprises an epoxy resin.

22. The structural adhesive composition according to claim 20, wherein the compound of formula I is Bis[3-(triethoxysilyl) propyl] disulfide.

23. The structural adhesive composition according to claim 20, wherein the compound of formula I is Bis[3-(triethoxysilyl) propyl] tetrasulfide.
